(19) United States
(12) Patent Application Publication
(10) Pub. No.: US 2015/0136046 A1
(43) Pub. Date: May 21, 2015

(54) METHOD FOR USING THE EXHAUST GASES FROM PLANTS FOR RAW IRON MANUFACTURE FOR GENERATING STEAM

(71) Applicant: SIEMENS VAI METALS TECHNOLOGIES GMBH, Linz (AT)

(72) Inventors: Robert Millner, Loosdorf (AT); Kurt Wieder, Schwertberg (AT); Johann Wurm, Bad Zell (AT)

(73) Assignee: SIEMENS VAI METALS TECHNOLOGIES GMBH, Linz (AT)

(21) Appl. No.: 14/395,944

(22) PCT Filed: Apr. 5, 2013
(86) PCT No.: PCT/EP2013/057174

§ 371 Date: Oct. 21, 2014

(30) Foreign Application Priority Data
May 3, 2012 (EP) 12166625.9

(51) Int. Cl. F22B 1/18; F27D 17/00

(52) U.S. Cl. CPC F22B 1/183; F27D 17/004; F22B 1/1838
USPC 122/7 A

(57) ABSTRACT

A method and a system for generating steam using the waste gases from plants for pig iron manufacture: waste gas removed as export gas (12) from the plant for pig iron manufacture is thermally utilized by combustion, and the waste gas from the combustion is fed to a heat-recovery steam generator (29). To utilize more energy from the export gas (12) for power generation, the export gas (12) is fed into a combustion chamber (23) located upstream of the heat-recovery steam generator (29), and after the combustion in the heat-recovery steam generator (29), heat is extracted from the export gas (12) without the export gas (12) passing through a gas turbine between combustion and heat-recovery steam generator. The pressure in the combustion chamber (23) and heat-recovery steam generator (29) are set above atmospheric pressure by means of a gas flow regulator (31) that is located downstream of the heat-recovery steam generator (29).

### CROSS-REFERENCE TO RELATED APPLICATIONS

The present application is a 35 U.S.C. §§371 National Phase conversion of PCT/EP2013/057174, filed Apr. 5, 2013, which claims priority of European Patent Application No. 12166625.9, filed May 3, 2012, the contents of which are incorporated by reference herein. The PCT International Application was published in the German language.

### FIELD OF THE INVENTION

The invention relates to a method for generating steam using waste gas from a plant for pig iron manufacture, with at least some of the waste gas being removed as export gas from the plant for pig iron manufacture and thermally utilized by means of combustion, and the waste gas from the combustion being fed to a heat-recovery steam generator.

### PRIOR ART

EP 1 255 973 A2 shows a method for utilization of waste heat from pig iron production in rotary hearth furnaces, with a low-calorific waste gas resulting from pig iron production being post-combusted into an inert gas in a steam generator together with combustion air, and with superheated steam being produced for a steam turbine process by heat exchange with the process gas.

In order to produce pig iron, where the intention is also to manufacture products similar to pig iron, there are essentially three known common methods: the blast furnace method, the direct induction method and the smelting induction method.

In direct induction plants iron ore is converted to sponge iron which is then further processed in the electric arc furnace to produce crude steel.

The smelting reduction method uses a melter gasifier in which hot liquid metal is produced, and at least one reduction reactor in which the iron ore-bearing material (lump ore, fines, pellets, sinter) is reduced with reduction gas, with the reduction gas being produced in the melter gasifier by gasification of coal (and possibly a small amount of coke) using oxygen (90% or more).

The following are usually provided in the smelting reduction method:
gas purification systems (on the one hand for top gas from the reduction reactor, and on the other hand for the reduction gas from the melter gasifier),
a compressor, preferably with aftercooler, for the reduction gas fed back into the reduction reactor,
a device for removal of CO₂, usually by means of pressure swing adsorption PSA), as per the prior art,
and optionally, a heater for the reduction gas and/or a combustion chamber for partial combustion with oxygen.

The COREX® process is a two-stage smelting reduction method. Smelting reduction combines the direct process (pre-reduction into sponge iron) with a melting process (main reduction).

The likewise known FINEX® process essentially corresponds to the COREX® process, but iron ore in the form of fines is involved.

It is known from WO 2008/086877 A2 for a COREX® plant to be coupled to a combined-cycle power plant. Here the export gas from the COREX® plant is combusted in a combustion chamber immediately located upstream of a gas turbine, the combusted export gas is processed in the gas turbine and is only then fed to a steam boiler where the thermal energy content of the combusted export gas is utilized to produce steam. The purpose of this method is to obtain a maximum possible nitrogen-free combustion gas which has a high proportion of CO₂.

A disadvantage of the method according to WO 2008/086877 A3 is that, firstly, a fuel compressor has to be used upstream of the gas turbine and the temperature of the export gas upstream of this gas turbine must be reduced to enable the compression to be economically implemented. In this case the export gas is mostly cooled down to approximately ambient temperature, for example to around 40° C. But due to this cooling, energy for the subsequent steam generation is lost. Secondly, prior to compression—usually above 20 bar —dust has to be removed from the export gas because top gas has a dust concentration of approximately 20 g/Nm³ and this would be too high for turbomachinery. Consequently, however, that energy in the dust for power generation contained in the combustible dust components is likewise lost.

The object of the invention is therefore to provide a method for using the waste gases from a plant for pig iron manufacture for electricity generation, which method uses more energy from the export gas for power generation than does the method according to WO 2008/086877 A2.

### DESCRIPTION OF THE INVENTION

The object is accomplished by a method disclosed herein wherein the export gas is conveyed to a combustion chamber that is located upstream of the heat-recovery steam generator and wherein heat is extracted from the export gas after combustion in the heat-recovery steam generator without the export gas passing through a gas turbine between combustion and the heat-recovery steam generator. The pressure in the combustion chamber and the heat-recovery steam generator is set above atmospheric pressure, in particular up to 3.5 bar_{g}, by setting the quantity of export gas which reaches the combustion chamber or the heat-recovery steam generator by means of a gas flow regulator which is located downstream of the heat-recovery steam generator.

A heat-recovery steam generator or waste heat boiler, for short, is a steam boiler which uses the hot waste gas from an upstream process to generate steam. A waste heat boiler has no combustion chamber and no burner, only heating surfaces or convection heating surfaces are disposed, over which the waste gas flows.

By omitting the gas turbine, the absolutely necessary compression and dedusting of the export gas and thus the cooling of the export gas upstream of the gas turbine are eliminated. Consequently, the sensible heat of the export gas is utilized for steam generation in the heat-recovery steam generator, with the export gas in the form of top gas from a reduction stack of a COREX® plant or from the fluidized-bed reactor of a FINEX® plant able to have a temperature of up to 500° C. In addition, the dust of this export gas contains up to 40 percent carbon which by means of combustion can be used for steam generation and is not lost by dedusting upstream of a gas turbine.

Accordingly, one embodiment of the invention makes provision for the export gas to be fed into the combustion chamber at a temperature above 100° C., preferably at a temperature above 200° , and most preferably at a temperature above 300° C.

Accordingly, an additional or alternate variant of the invention makes provision for the export gas to contain at least one portion of 5-40 g/Nm³ of carbon carriers, with this portion in turn containing 5-40% elemental carbon. The export gas can, however, also contain hydrocarbons, in particular aromatic hydrocarbons such as benzene, combusted in the combustion chamber and thus on the one hand rendered harmless and on the other hand used for heat generation. In this case, however, no gas purification or only an appropriately small amount of gas purification may occur between the reduction reactor and the combustion chamber.

An alternate embodiment of the inventive solution consists in that, instead of using the combustion chamber upstream of the heat-recovery steam generator, one or a plurality of burners which combust the export gas are located within the heat-recovery steam generator, as is already known from AT 340 452 B. Here the waste gas from reduction reactors is likewise combusted in a steam generator, but in that case the generation of the reduction gases differs from that in the COREX® or FINEX® processes. According to AT 340 452 B, iron-bearing materials and material containing carbon are placed together in a pre-reduction zone designed as a fluidized bed where the material containing carbon is converted into a reducing gas by partial combustion. The iron-bearing material, again together with further material containing carbon, is then placed in a final reduction zone where molten pig iron is produced with the aid of electric current. Only a part of the carbon carrier material is used for the manufacture of pig iron, the rest is extracted in the form of combustible gas and combusted in the steam generator and converted into electrical energy or with the aid of a turbine generator.

With the method according to AT 340 452 B and the details given there in relation to the blast furnace, the production of coke could be dispensed with. As a further advantage, it is stated that the entire gasification takes place in the iron production stage, namely in the fluidized bed itself. This again is significantly different from the COREX® or FINEX® processes where the reduction gas is produced in a unit differing from the reduction reactor or reactors, namely the melter gasifier. Again in the case of direct reduction, the reduction gas, possibly in the form of natural gas, is introduced into the reduction stack which is usually constructed as a fixed bed.

The inventive combustion chamber is usually clad, for example lined, with refractory materials. It can be operated in conjunction with the heat-recovery steam generator either at atmospheric pressure or overpressure. The overpressure can be up to around 3.5 bar_{g} (=3.5×10⁵ Pa).

Since combustion chamber and heat-recovery steam generator are operated under pressure, the quantity of export gas which reaches the combustion chamber can be set by setting the overpressure in the combustion chamber and in the heat-recovery steam generator. This means that no control valve is provided in the pipeline which carries the export gas from the plant for the manufacture of pig iron to the combustion chamber. Instead, the performance of the heat-recovery steam generator is directly matched to the plant for the manufacture of pig iron so that both are coupled together with equal pressure. A special high-temperature flare for the plant for the manufacture of pig iron can therefore also be dispensed with as the export gas is converted in the combustion chamber both in the start-up and shut-down modes of the plant for the manufacture of pig iron. In the event of an outage of the plant for the manufacture of pig iron a replacement fuel (natural gas for example) can be used, which is burnt in the combustion chamber via a special burner. At the same time, the export gas pipeline is isolated from the combustion chamber by means of shut-off valves.

Since the waste gas escaping from the reduction reactor (the reduction stack in the COREX® process, the fluidized bed reactors in the FINEX® process, the reduction stack in the direct reduction process) is loaded with dust, the export gas extracted from this waste gas must be dedusted before it can be released into the atmosphere following its combustion. There is a variety of dedusting options:

According to the first embodiment the waste gas escaping from at least one reduction reactor of the plant for the manufacture of pig iron is not dedusted upstream of the heat-recovery steam generator and only the combusted export gas emitted from the heat-recovery steam generator is dedusted. This has the advantage that the carbon component of the dust is completely combusted and can be used for steam generation. It is assumed, however, that the burner in the combustion chamber and the heating surfaces of the heat-recovery steam generator are designed for dust loads of up to 5 g/Nm³.

Otherwise, according to a second embodiment, provision must at least be made for the gas emitted from at least one reduction reactor of the plant for the manufacture of pig iron to be coarsely dedusted upstream of the heat-recovery steam generator and the combusted export gas emitted from the heat-recovery steam generator is finely dedusted. Coarse dedusting should always be carried out dry, for example using a cyclone, so that the waste gas or export gas is not cooled. In the case of wet scrubbing, water systems and sludge handling would also be required and the iron-bearing material and the carbon from the dust would be lost with the sludge.

Or, according to a third embodiment, to reduce the dust load in the burner or in the heat-recovery steam generator, provision can also be made for the waste gas emitted from at least one reduction reactor of the plant for the manufacture of pig iron to be finely dedusted upstream of the heat-recovery steam generator and the combusted export gas emitted from the heat-recovery steam generator not to be dedusted. In this case coarse dedusting, for instance using a cyclone, is usually implemented initially upstream of the burner and then fine dedusting, for instance using a ceramic filter, electrostatic filter or fabric filter. Coarse and fine dedusting are carried out dry.

In every case the pressure energy of the export gas upstream of the combustion chamber can be reduced via an expansion turbine or via a valve. The pressure of the export gas is usually between 8 and 12 bar_{g}. The use of an expansion turbine has the advantage that a portion of the sensible heat is thermodynamically utilized and the export gas temperature due to expansion is reduced by approximately 100-150° C. In the case of an expansion turbine, the control for setting the quantity of export gas can be disposed upstream of the heat-recovery steam generator and the latter must not necessarily be constructed as a pressure vessel, because it must not be operated under pressure.

In a preferred variant of the inventive method, the energy for the reduction of the iron ore in the manufacture of pig iron is supplied exclusively in the form of fuels. This is significantly different from the method according to AT 340 452 B because there, electrical current is used for reduction in the final reduction stage.

The inventive method is preferably realized in conjunction with pig iron manufacture in accordance with the
smelting reduction method or
direct reduction method.

Accordingly, the export gas contains at least one of the following waste gases:
waste gas from a melter gasifier of a smelting reduction plant,
waste gas from at least one fluidized bed reactor or reduction stack of a smelting reduction plant,
waste gas from at least one fixed bed reactor for preheating and/or reduction of iron oxides and/or iron briquettes of a smelting reduction plant,
waste gas from a reduction stack of a direct reduction plant.

In the case of the smelting reduction or direct reduction method the quantity of export gas is advantageously set downstream of the heat-recovery steam generator, that is to say where applicable, after the combusted export gas emitted from the heat-recovery steam generator has been dedusted.

The inventive system for implementing the method comprises at least
a plant for the manufacture of pig iron,
an export gas pipeline by which a portion of the waste gas can be removed from the plant for pig iron manufacture,
a combustion chamber into which the export gas pipeline leads and where the export gas can be combusted,
a heat-recovery steam generator coupled downstream from the combustion chamber in which the waste gas from the combustion chamber can be utilized for steam generation, said heat-recovery generator being connected downstream of the combustion chamber. The inventive plant is characterized in that the heat-recovery steam generator is directly coupled downstream of the combustion chamber and in that no other unit, in particular no gas turbine, is located between combustion chamber and heat-recovery steam generator. The inventive plant is further characterized in that a gas flow regulator is disposed downstream of the heat-recovery steam generator for setting the pressure above atmospheric pressure
   in the combustion chamber and heat-recovery steam generator.

So that the combustion chamber and the heat-recovery steam generator can be operated under pressure, provision can be made for the combustion chamber and the heat-recovery steam generator to be designed as a pressure vessel which can withstand an internal pressure of up to 3.5 bar_{g}.

The different dedusting variants resulting from the inventive plant are as follows:
no dedusting system is located between at least one reduction reactor of the plant for pig iron manufacture and the heat-recovery steam generator and at least one dedusting system is located downstream of the heat-recovery steam generator,
at least one coarse dedusting system is located between at least one reduction reactor of the plant for pig iron manufacture and the heat-recovery steam generator and at least one fine dedusting system is located downstream of the heat-recovery steam generator,
at least one fine dedusting system is located between at least one reduction reactor of the plant for pig iron manufacture and the heat-recovery steam generator and no dedusting system is located downstream of the heat-recovery steam generator.

In order to reduce the pressure energy of the export gas, provision can be made for an expansion turbine or a valve to be located upstream of the combustion chamber.

According to a preferred embodiment of the invention, in order to realize reduction, pipelines for fuels lead exclusively into the reduction reactors of the plant for pig iron manufacture. Power lines, as in AT 340 452 B, are therefore excluded. This fuel is coal in the case of a COREX® or FINEX® plant.

Accordingly, the plant for pig iron manufacture preferably includes:
a smelting reduction system or
a direct reduction system and a pipeline is provided by which
waste gas can be carried from a melter gasifier of a smelting reduction system,
waste gas can be carried from at least one fluidized bed reactor or reduction stack of a smelting reduction system,
waste gas can be carried from at least one fixed bed reactor for preheating and/or reduction of iron oxides and/or iron briquettes of a smelting reduction system,
waste gas can be carried from a reduction stack of a direct reduction system in the export gas pipeline.

In the case of a smelting or direct reduction system, the gas flow regulator can be located downstream of the heat-recovery steam generator and in fact, where necessary, downstream of the dedusting system or the fine dedusting system.

With the inventive method or the inventive equipment, the sensible heat of the export gas can be used for steam or power generation, without a special heat-recovery boiler having to be installed for the top gas or another waste gas from plants for pig iron manufacture. Here the inventive heat-recovery steam generator assumes both the function of a conventional heat-recovery boiler for the top gas or another waste gas as well as the function of the steam generator of the steam power station.

By eliminating the wet dedusting, no or at least less process water is needed during pig iron manufacture. In two of the three proposed variants for dedusting, the cost of dedusting of pig iron manufacture is reduced by the partial re-siting of the dedusting system downstream of the heat-recovery steam generator. Due to the lower pressure losses resulting from savings in gas purification systems, the pressure of the export gas upstream or downstream of the heat-recovery steam generator can be used in an expansion turbine.

The inventive separated dust is obtained either dry or wet and is burned in the combustion chamber or forms slag. There is therefore less or no dust as sludge, which may reduce the amount of sludge.

Emissions can be reduced because due to the invention the quantity of process water is at least reduced and the hydrocarbons contained in the export gas are burned in the combustion chamber. Compared to plants with gas turbines, corrosion due to condensation of polycyclic aromatic hydrocarbons, abbreviated to PAH, by way of the export gas is reduced or even avoided by higher gas temperatures.

### BRIEF DESCRIPTION OF THE FIGURES

The invention is explained in detail below with the aid of the exemplary and schematic figures.

FIG. 1 shows a plant schematic without dedusting of the export gas (top gas) upstream of the heat-recovery steam generator,

FIG. 2 shows a plant schematic with dedusting of the export gas (top gas) upstream of the heat-recovery steam generator,

FIG. 3 shows an inventive plant with a COREX® plant and dry dedusting of the top gas,

FIG. 4 shows an inventive plant with a COREX® plant and partial wet cleaning of the top gas,

FIG. 5 shows an inventive plant with a FINEX® plant and dry dedusting of the top gas,

FIG. 6 shows an inventive plant with a FINEX® plant and partial wet cleaning of the top gas.

### DESCRIPTION OF EMBODIMENTS

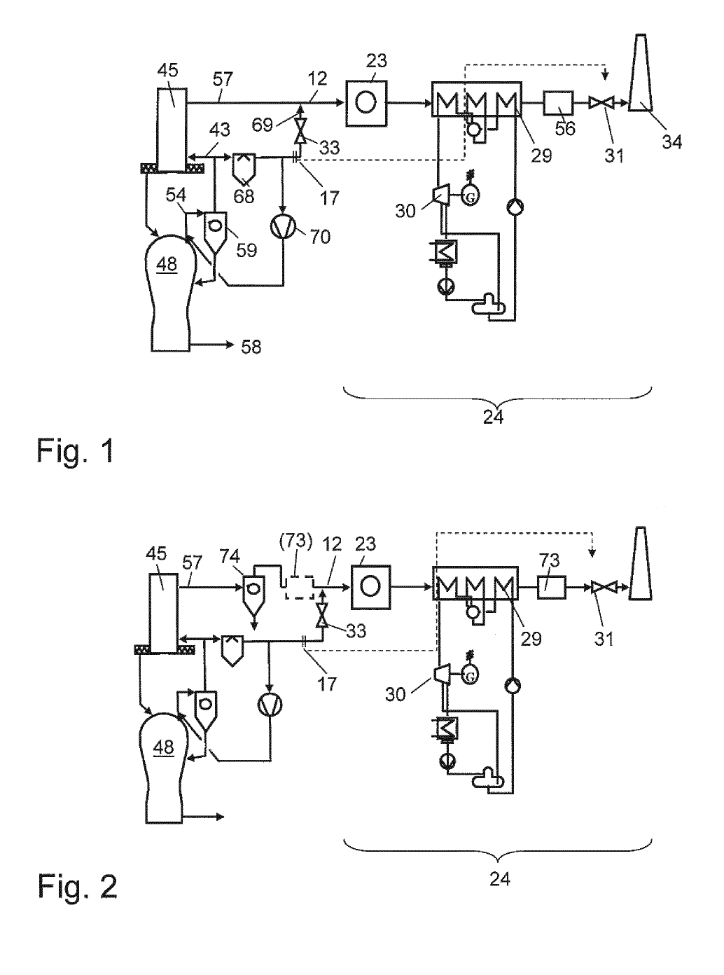

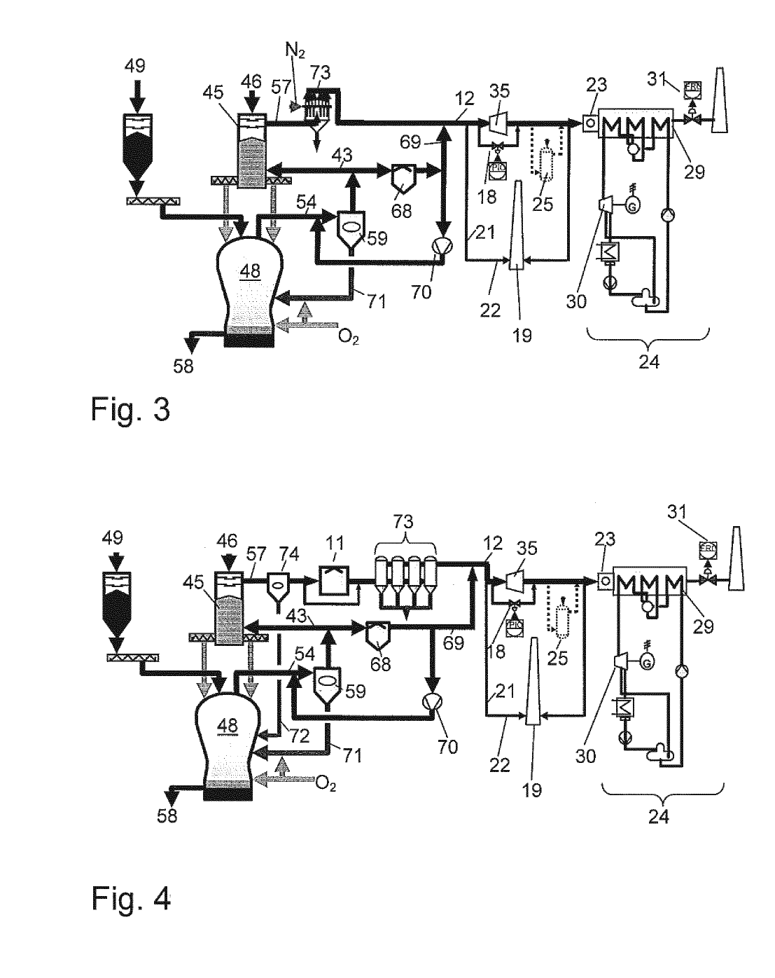

FIG. 1 shows a plant schematic without dedusting of the export gas 12 (top gas) upstream of the heat-recovery steam generator 29. The plant for the manufacture of pig iron represented here is a COREX® plant whose precise mode of operation is to be found in the description of FIG. 3. However, any other plant for pig iron manufacture could convey export gas 12 to the combustion chamber 23.

The COREX® plant has a reduction stack 45 which is constructed as a fixed bed reactor and is loaded with lump ore, pellets, sinter and additives; refer to reference number 46 in FIG. 3. The reduction gas 43 is fed as a countercurrent to the lump ore, etc. It is introduced at the base of the reduction stack 45 and emerges at its upper end as top gas 57. The top gas 57 from the reduction stack 45 is not cleaned and at least one part of it is extracted as export gas 12 from the COREX® plant. Refer to FIG. 3 regarding the further use of the top gas 57.

The reduction gas 43 for the reduction stack 45 is produced in a melter gasifier 48 into which on the one hand coal is fed and on the other hand the iron ore pre-reduced in the reduction stack 45 is added. The coal in the melter gasifier 48 is gasified, the resulting gas mixture is drawn off as top gas (generator gas) 54 and a partial flow is fed to the reduction stack 45 as reduction gas 43. The molten, hot metal and the slag in the melter gasifier 38 are removed, see arrow 58.

The generator gas 54 removed from the melter gasifier 48 is conveyed into a separator 59 to separate and dry it with discharged dust and to return the dust to the melter gasifier 48 via the dust burner. A portion of the top gas 54 cleaned of coarse dust is further cleaned by means of the wet washer 68 and removed from the COREX® plant as surplus gas 69 and mixed with the top gas 57 or the export gas 12.

A portion of the cleaned top gas or generator gas 54 downstream of the wet washer 68 is fed to a gas compressor 70 for cooling and is again fed to the top gas or generator gas 54 for cooling downstream of the melter gasifier 48. Due to this return the reduced components contained therein can still be utilized for the COREX® plant and, on the other hand, the required cooling of the hot top gas or generator gas 54 from approximately 1050° C. to 700-900° C. can be ensured.

The quantity of the surplus gas 69 that is fed to the export gas 12 is measured with a flowmeter 17 and, depending on the measured flow, adjusts a gas flow regulator 31 located in the waste line downstream of the heat-recovery steam generator 29. The pressure regulator 33 located in the direction of flow of the surplus gas 69 downstream of the flowmeter 17, opens the valve assigned to it to the extent that the pressure in the melter gasifier 48 does not exceed a predetermined value. The location of the gas flow regulator 31 downstream of the heat-recovery steam generator 29 is advantageous because at that point the gas temperature is lower than the temperature of the export gas upstream of the combustion chamber 23.

The surplus gas 69 has a higher pressure and a higher temperature than the top gas 57, which can be used to clean the surplus gas in a wet washer 68 and then to feed it to the top gas 57. The same applies to the surplus gas 61 which is cleaned in a wet washer 60, and the waste gas 44 of a FINEX® plant. Since this wet washer 68 in the COREX® plant also cools the returned generator gas, this would have to be cooled possibly by water injection if the surplus gas 69 is not to be cooled by a wet washer, but rather if its energy were utilized for the heat-recovery steam generator 29.

The export gas 12, consisting of surplus gas 69 and top gas 57, is conveyed into the combustion chamber 23 and combusted there. The waste gas from the combustion chamber 23 is conveyed directly into the heat-recovery steam generator 29, where it generates steam for the steam circuit including a steam turbine 30. The waste gas emerging from the heat-recovery steam generator 29 is dried and dedusted in a dedusting system 56, which here is designed as a combination of coarse dedusting and fine dedusting, and conveyed into the atmosphere through the chimney stack 34.

The plant as shown in FIG. 2 corresponds for the most part to those plant components in FIG. 1, with the difference that in FIG. 2 upstream of the heat-recovery steam generator 29, that is to say downstream of the reduction stack 45 and upstream of the inlet of the surplus gas 69, dry dedusting of the top gas 57 takes place in a coarse dedusting system 74. For this, another—in particular dry —fine dedusting system 73 (for example with ceramic filters, electrostatic filters or fabric filters) must then be located downstream of the heat-recovery steam generator 29. This embodiment can then be used if the burner and the heat exchanger of the heat-recovery steam generator 29 are designed for export gas 12 or waste gas having a dust content of approximately 5 g/Nm³. Otherwise, for this purpose, were the fine dedusting system 73 also to be located upstream of the combustion chamber 23 (and downstream of the coarse dedusting system 74—see dotted lines) it could be omitted from the location downstream of the heat-recovery steam generator 29.

The same applies to the location of the gas flow regulator 31 in FIG. 2; if this withstands a dust loading of approximately 5 g/Nm³ and temperatures of 300-500° C., this can also be directly located downstream of the dry coarse dedusting, that is to say downstream of the coarse dedusting system 74.

FIG. 3 shows the inventive link between a COREX® plant with on the one hand dry dedusting of the top gas and a power plant 24.

From a COREX® plant the power plant 24 is supplied with export gas 12, which can be temporarily stored in an export gas tank (not shown). Export gas 22 not required for the power plant 24—as shown here—can be fed to the flare stack 19 or to the smelting plant gas network, or for instance to a raw material drying plant. The pressure energy content of the export gas 12 can also be utilized in an expansion turbine 35 (or top gas pressure recovery turbine), which in this example is located upstream of the pipeline 21 for export gas 22 to the flare stack. A corresponding bypass for the export gas 12 around the expansion turbine 35 is provided if the export gas 12 should not be passed through the expansion turbine 35—for instance due to low pressure. A corresponding pressure-controlled valve 18 is provided in the bypass. The export gas 12 is fed to the combustion chamber 23 as fuel, and if necessary preceding this, cooled by a gas cooler 25. The combusted export gas is directly conveyed from the combustion chamber 23 into the heat-recovery steam generator 29. At this point the combusted export gas gives up its heat to the heat exchanger (hot surfaces); the resulting steam drives the steam turbine 30 and its connected generator for power generation.

In this example, the COREX® plant has a reduction stack 45 which is constructed as a fixed bed reactor and is charged with lump ore, pellets, sinter and additives; see reference number 46. The reduction gas 43 is fed to the lump ore etc. 46 as a countercurrent. It is introduced at the base of the reduction stack 45 and emerges at its top side as top gas 57. The top gas 57 from the reduction stack 45 is dry dedusted in a fine deduster unit 73, here constructed as a hot gas filter with ceramic filters, and at least one portion is extracted from the COREX® plant as export gas 12. A portion could be purged of CO₂ via a PSA (Pressure Swing Adsorption) unit—not shown here—located in the COREX® plant and again fed to the reduction stack 45.

The reduction gas 43 for the reduction stack 45 is produced in a melter gasifier 48 into which coal in the form of lump coal 49, if necessary with fines, is introduced. In addition, oxygen O₂ is supplied. Otherwise, pre-reduced iron ore is fed to the reduction stack 45. The coal in the melter gasifier 48 is gasified, resulting in a gas mixture that mainly consists of CO and H₂, and is withdrawn as top gas (generator gas) 54 and a partial flow is conveyed as reduction gas 43 to the reduction stack 45. The hot molten metal and the slag in the melter gasifier 48 are extracted, see arrow 58.

The generator gas 54 drawn from the melter gasifier 48 is conveyed to a separator 59 which is constructed as a hot-gas cyclone, to dry and separate it along with deposited dust 71, in particular fines, and convey the dust 71 via the dust burner into the melter gasifier 48. A portion of the top gas 54, cleaned of coarse dust, is further cleaned by means of the wet washer 68 and removed as surplus gas 69 from the COREX® plant and mixed with the top gas 57 or the export gas 12. The control of the quantity of the surplus gas 69 has already been described in FIG. 1.

A portion of the cleaned top gas or generator gas 54 downstream of the wet washer 68 is conveyed for cooling a gas compressor 70 and then fed again to the top gas or generator gas 54 downstream of the melter gasifier 48 for cooling. Due to this recirculation the reducing components contained therein can be further utilized for the COREX® process and, on the other hand, can ensure the necessary cooling of the hot top gas or generator gas 54 from approximately 1050° C. to 700-900° C.

The reduction stack 45 does not have to be constructed as a fixed bed but can also be constructed as a fluidized bed. Depending on the raw materials charge and depending on process control, either sponge iron, hot iron briquettes or low-reduced iron are removed at the lower end.

The export gas 12 passes downstream of the fine dedusting unit 73 and finally reaches the combustion chamber 23 where it is combusted and then directly conveyed into the heat-recovery steam generator 29. Any surplus export gas 12 can also be bled off to the flare stack 19 between expansion turbine 35 and combustion chamber 23, if necessary downstream of the gas cooler 25. The gas flow regulator 31 which is controlled by the flowmeter 17 (not shown here—see FIG. 1 and FIG. 2) is provided downstream of the heat-recovery steam generator 29.

The plant and the function of the plant as shown in FIG. 3 corresponds in other respects to that of FIG. 2.

The plant in FIG. 4 largely corresponds to that in FIG. 3, but the dedusting of the top gas 57 is realized differently: instead of a fine dedusting unit 73 in the form of a hot-gas filter as in FIG. 3, dry coarse dedusting takes place in a coarse dedusting unit 74 (cyclone), followed by a wet washer 11, followed by a fine dedusting unit 73 in the form of several fabric filters. A bypass line for the top gas 57 is provided around the wet washer 11 to bypass the top gas wet wash.

The dust 72 from the coarse dedusting unit 74 can be fed back into the melter gasifier 48.

Here the gas flow regulator 31 is likewise provided downstream of the heat-recovery steam generator 29.

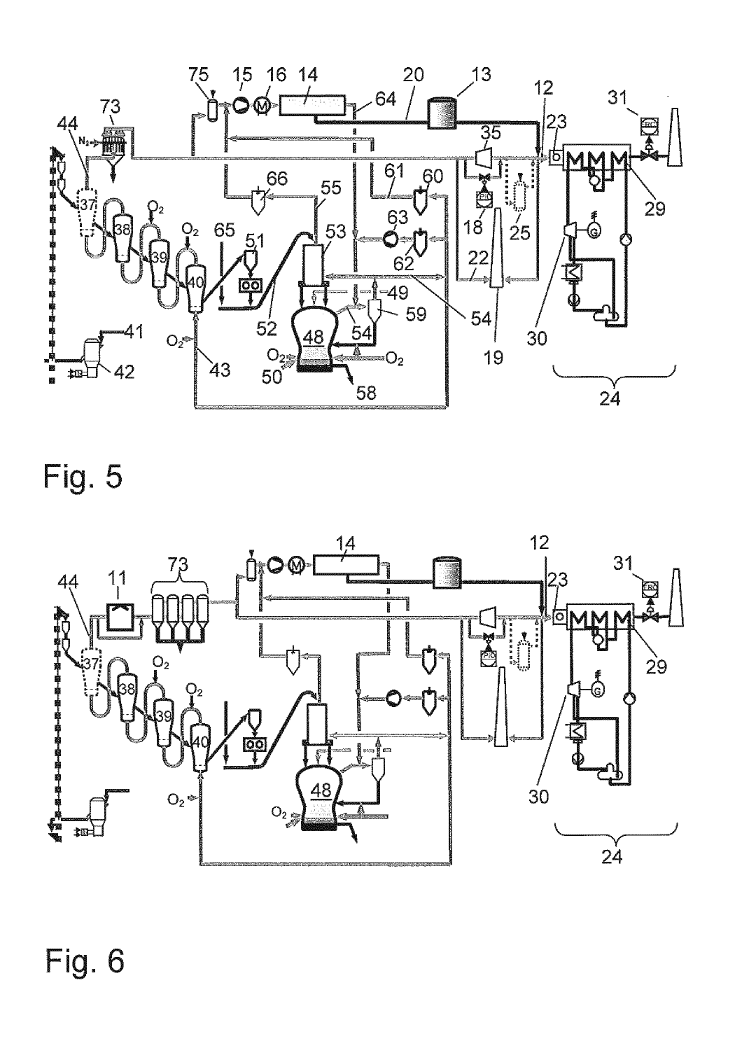

In FIG. 5 the power plant 24 is supplied with export gas 12 from a FINEX® plant, which can be temporarily stored in an export gas tank 13. Export gas 22 not required for the power plant 24 can again be fed to the smelter plant gas network, for instance to a raw material drying plant or to the flare stack 19.

The FINEX® plant has in this example four fluidized bed reactors 37-40 as reduction reactors, which are charged with fines. Fines and additives 41 are fed to the initial drying unit 42 and from there first to the fourth reactor 37, then reach the third 38, the second 39 and finally the first fluidized bed reactor 40. However, instead of four fluidized bed reactors 37-40, there can also be only three. The reduction gas 43 is conveyed to the fines by a countercurrent. It is introduced at the base of the first fluidized bed reactor 40 and emerges at its top side. Before it enters from below into the second fluidized bed reactor 39 it can also be heated with oxygen O₂, likewise between the second 39 and the third 38 fluidized bed reactor. The waste gas 44 from the fluidized bed reactors 37-40 is cleaned in a fine dedusting unit 73 which is constructed as a hot-gas filter with ceramic filter elements, and further utilized as export gas 12 in the downstream combined-cycle power plant 24.

The reduction gas 43 is produced in a melter gasifier 48 in which, on the one hand, coal in the form of lump coal 49 and coal in powder form 50 is fed in along with oxygen O₂ and to which on the other hand is added the iron ore pre-reduced in the fluidized reactors 37-40 and formed into hot briquettes (HCI—Hot Compacted Iron) in the iron briquetting unit 51. In this case the iron briquettes arrive via a conveyor 52 at a storage container 53 which is constructed as a fixed bed reactor where the iron briquettes are if necessary pre-heated and reduced with coarsely cleaned generator gas 54 from the melter gasifier 48. Here cold iron briquettes 65 can also be added. Finally, the iron briquettes or iron oxide are loaded from above into the melter gasifier 48. Low-reduced iron (LRI) can likewise be removed from the briquetting unit 51.

The coal in the melter gasifier 48 is gasified, resulting in a gas mixture that principally consists of CO and H₂, and is bled off as reduction gas (generator gas) 54 and a partial flow is conveyed as reduction gas 43 to the fluidized bed reactors 37-40. The molten, hot metal and the slag in the melter gasifier 48 are removed, see arrow 58.

The top gas 54 removed from the melter gasifier 48 is first conveyed to a separator 59 (hot-gas cyclone), to dry and separate it along with deposited dust, and to return the dust via the dust burner to the melter gasifier 48. A portion of the top gas, with coarse dust removed, is further cleaned by means of the wet washer 60 and removed as surplus gas 61 from the FINEX® plant; a portion can also be fed to the PSA (Pressure Swing Adsorption) unit 14 to remove CO₂. A pressure regulator similar to the pressure regulator 33 in FIG. 1 and FIG. 2, with which the pressure required for the melter gasifier 48 is set, is located in the pipeline for surplus gas 61.

A further portion of the cleaned generator gas 54 is likewise cleaned in a wet washer 62 and conveyed to a gas compressor 63 for cooling and then after mixing with the product gas 64, which is taken from the PSA unit 14 with CO₂ removed, and again fed to the generator gas 54 for cooling, downstream of the melter gasifier 48. Due to this recirculation of the gas 64, now with CO₂ removed, the reducing components contained therein can again be used for the FINEX® process and, on the other hand, can ensure the necessary cooling of the hot generator gas 54 from approximately 1050° C. to 700-870° C.

The top gas 55 emerging from the storage unit 53, where the iron briquettes or iron oxide are heated and reduced with dedusted and cooled generator gas 54 from the melter gasifier 48, is cleaned in a wet washer 66 and then likewise at least partially fed to the PSA unit 14 for removal of CO₂. A portion can also be added to the waste gas 44 from the fluidized bed reactors 37-40.

A portion of the waste gas 44 from the fluidized bed reactors 37-40 can also be added directly to the PSA unit 14. The gases to be conveyed to the PSA unit 14 are cooled beforehand in a gas cooler 75, which like the gas cooler 25, operates on the basis of cold water, are compressed in a compressor 15 and then cooled in an aftercooler 16.

The residual gas 20 from the PSA unit 14 can be completely or partially mixed with the export gas 12, for instance via a residual gas tank 13 for homogenizing the quality of the residual gas. However, it can also be added via the unwanted export gas 22 to the smelting plant's gas network or to the flare stack 19 for combustion, as already described in conjunction with FIG. 3.

The pressure of the waste gas 44 from the fluidized bed reactors 37-40 can be utilized in an expansion turbine 35, just as illustrated in FIGS. 3 and 4, and then if necessary be partially cooled in a gas cooler 25 based on cold water, upstream of the combustion chamber 23.

Otherwise, plant construction and function of the combustion chamber 23 coincides with that of FIGS. 3 and 4. The gas flow regulator 31 is located downstream of the heat-recovery steam generator 29.

Except for the dedusting of the waste gas 44, the construction shown in FIG. 6 coincides with that of FIG. 5. In FIG. 6 a wet washer 11 is initially located in the pipeline for the waste gas 44 from the fluidized bed reactors 37-40, said wet washer being able to be partially bypassed via a bypass line as shown in FIG. 4 in order to achieve the best possible inventive effect of the hottest possible waste gas 44 or export gas 12.

A fine dedusting system 73 in the form of several fabric filters in which the waste gas is dried and fine dust is removed, is connected downstream of the wet washer 11. Here the gas flow regulator 31 is located as shown in FIG. 5.

### LIST OF REFERENCE NUMBERS

11 Wet washer
12 Export gas
13 Residual gas tank
14 PSA unit
15 Compressor
16 Aftercooler
17 Flowmeter
18 Pressure regulator for expansion turbine 35
19 Flare stack
20 Residual gas
21 Pipeline for export gas to flare stack 19
22 Not required export gas
23 First metering device for measuring calorific value
24 Power plant
25 Gas cooler
26 Filter
27 Gas compressor
28 Gas turbine
29 Heat-recovery steam generator
30 Steam turbine
31 Gas flow regulator
32 Pipeline for residual gas to smelting plant gas network or flare stack 19
33 Pressure regulator for surplus gas 69
34 Chimney stack
35 Expansion turbine
37 Fourth fluidized bed reactor
38 Third fluidized bed reactor
39 Second fluidized bed reactor
40 First fluidized bed reactor
41 Fines and additives
42 Ore drying
43 Reduction gas
44 Waste gas from fluidized bed reactors 37-40
45 Reduction stack
46 Lump ore, pellets, sinter and additives
48 Smelter gasifier
49 Lump coal
50 Coal in powder form
51 Iron briquetting
52 Conveyor
53 Storage tank constructed as fixed bed reactor for preheating and reduction of iron oxides and/or iron briquettes
54 Top gas or generator gas from smelter gasifier
55 Top gas from wet washer 66
56 Dedusting unit
57 Top gas from reduction stack 45
58 Hot metal and slag
59 Separator for fines
60 Wet washer
61 Surplus gas
62 Wet washer
63 Gas compressor
64 Gas (product gas) from PSA unit 14, with CO2 removed
65 Cold iron briquettes
66 Wet washer
67 Wet washer downstream of reduction stack 45
68 Wet washer downstream of separator for fines 59
68 Surplus gas from COREX® plant
70 Gas compressor downstream of wet washer 68
71 Dust from separator 59
72 Dust from coarse dedusting unit 74
73 Fine dedusting unit
74 Coarse dedusting unit
75 Gas cooler upstream of PSA unit 14

1-19. (canceled)

20. A method for generating steam using waste gas from a plant for pig iron manufacture, the method comprising:
removing at least some of the waste gas as export gas from the plant for pig iron manufacture, conveying the export gas to a combustion chamber which is located upstream of a heat-recovery steam generator, thermally utilizing the waste gas by combustion, and feeding the waste gas from the combustion to a heat-recovery steam generator, and extracting heat from the export gas after combustion of the export gas in the heat-recovery steam generator, without passing the export gas through a gas turbine between the combustion and the heat-recovery steam generator;
setting the pressure in the combustion chamber and the heat-recovery steam generator above atmospheric pressure, by setting a quantity of export gas which reaches the combustion chamber or the heat-recovery steam generator via a gas flow regulator which is located downstream of the heat-recovery steam generator;
wherein the waste gas emerges from at least one reduction reactor of the plant for the manufacture of pig iron, and the waste gas is not dedusted upstream of the heat-recovery steam generator and only the combusted export gas emerging from the heat-recovery steam generator is dedusted, or is not dedusted upstream of the heat-recovery steam generator and only the combusted export gas emerging from the heat-recovery steam generator is dedusted, or is coarsely dedusted upstream of the heat-recovery steam generator and the combusted export gas emerging from the heat-recovery steam generator is finely dedusted.

21. The method as claimed in claim 20, further comprising:
conveying the export gas to the combustion chamber at a temperature above 100° C.

22. The method as claimed in claim 20, wherein the export gas contains at least one portion of 5-40 g/Nm³ of carbon carriers, and wherein the one portion contains 5-40% of elemental carbon.

23. The method as claimed in claim 20, wherein energy for the reduction of iron ore in the manufacture of pig iron is supplied exclusively in the form of fuels.

24. The method as claimed in claim 20, wherein the manufacture of pig iron is carried out according to a smelting reduction method or a direct reduction method.

25. The method as claimed in claim 20, wherein the export gas contains at least one of the following waste gases:
waste gas from a melter gasifier of a smelting reduction plant;
waste gas from at least one fluidized bed reactor or reduction stack of a smelting reduction plant;
waste gas from at least one fixed bed reactor for preheating and/or reduction of iron oxides and/or iron briquettes of a smelting reduction plant; and
waste gas from a reduction stack of a direct reduction plant.

26. The method as claimed in claim 24, further comprising setting the quantity of gas for the smelting reduction method or for the direct reduction method at a location downstream of the heat-recovery steam generator, after the combusted export gas emerging from the heat-recovery steam generator has been dedusted.

27. A plant for carrying out a method as claimed in claim 20, comprising:
a plant for manufacture of pig iron;
an export gas pipeline configured for removing one portion of the waste gas as export gas from the plant;
a combustion chamber into which the export gas pipeline leads and configured so that the export gas can be combusted in the combustion chamber;
a heat-recovery steam generator connected downstream of the combustion chamber, and configured for using the waste gas from the combustion chamber for steam generation;
a gas flow regulator located downstream of the heat-recovery steam generator to set the pressure in the combustion chamber and in the heat-recovery steam generator above atmospheric pressure; a reduction reactor in the plant;
no dedusting system is located between the reduction reactor of the plant for the manufacture of pig iron and the heat-recovery generator, and a dedusting system is located downstream of the heat-recovery steam generator, or
a coarse dedusting system located between the reduction reactor of the plant and the heat-recovery steam generator and a fine dedusting system is located downstream of the heat-recovery steam generator; or
a fine dedusting system is located between the reduction reactor of the plant and the heat-recovery steam generator and no dedusting system is located downstream of the heat-recovery steam generator.

28. The plant as claimed in claim 27, wherein the combustion chamber and the heat-recovery steam generator are pressure vessels which are configured to withstand an internal pressure of up to 3.5 bar_{g}.

29. The plant as claimed in claim 27, further comprising pipelines for fuels lead exclusively into the plant for the manufacture of pig iron for realizing the reduction in the reduction reactor.

30. The plant as claimed in claim 27, wherein the plant for the manufacture of pig iron includes a smelting reduction system or a direct reduction system.

31. The plant as claimed in claim 27, wherein the pipeline is configured for at least one of: conveying waste gas from a melter gasifier of a smelting reduction plant;
conveying waste gas from at least one fluidized bed reactor or reduction stack of a smelting reduction system;
conveying waste gas from a fixed bed reactor for preheating and/or reduction of iron oxides and/or iron briquetting;
conveying waste gas into the export gas pipeline from a reduction stack of a direct reduction system.

32. The plant as claimed in claim 30, wherein the gas flow regulator is located downstream of the heat-recovery steam generator, and downstream of the dedusting system or the fine dedusting system in the case of a smelting reduction system or a direct reduction system.
